(19) United States
(12) Patent Application Publication
(10) Pub. No.: US 2008/0271447 A1
(43) Pub. Date: Nov. 6, 2008

(54) METHOD AND APPARATUS FOR SUPPLYING AIR TO AN EMISSION ABATEMENT DEVICE BY USE OF A TURBOCHARGER

(76) Inventors: John B. Abel, Freetown, IN (US); Navin Khadiya, Columbus, IN (US); Samuel N. Crane, Columbus, IN (US)

Correspondence Address: BARNES & THORNBURG LLP, 11 SOUTH MERIDIAN, INDIANAPOLIS, IN, 46204, US

(21) Appl. No.: 11/744,019

(22) Filed: May 3, 2007

(51) Int. Cl. F02B 33/44

(52) U.S. Cl. 60/598

(57) ABSTRACT

A method includes supplying combustion air to a fuel-fired burner of an emission abatement device from a turbocharger. During periods of low turbo boost pressure, combustion air is supplied to the fuel-fired burner from an auxiliary source. An associated apparatus is also disclosed.

### FIELD OF THE DISCLOSURE

The present disclosure relates generally to emission abatement devices.

### BACKGROUND OF THE DISCLOSURE

Emission abatement devices are used to treat a variety of emissions of exhaust gas. For example, there are emission abatement devices which serve to remove particulate matter and NOx (i.e., oxides of nitrogen) from the exhaust gas of internal combustion engines such as diesel engines.

### SUMMARY OF THE DISCLOSURE

According to an aspect of the present disclosure, there is provided an apparatus including an internal combustion engine, an emission abatement device having a fuel-fired burner, and a turbocharger. The turbocharger is driven by exhaust gas from the engine and supplies pressurized air to the fuel-fired burner. During periods of low turbo boost pressure, combustion air is supplied to the fuel-fired burner by a supplemental pressurized air source.

The supplemental pressurized air source may be an air tank of a vehicle air brake system. The supplemental pressurized air source may also be embodied as an auxiliary electric air pump such as those used with exhaust catalysts. A separate compressor, such as a supercharger, may be used as the supplemental pressurized air source.

Depending on the configuration of the system, the supplemental pressurized air source may take the form of a valve which directs a greater portion of the engine's exhaust gas through the combustion chamber of the fuel-fired burner during low turbo boost conditions.

Further, the supplemental pressurized air source may integrated into the turbocharger, along with an associated control configuration. For example, an electrically assisted turbocharger may be used and mechanically operated by the engine's exhaust gas during normal operation, but then electrically operated to maintain combustion air supply to the fuel-fired burner if the turbo boost pressure falls below a predetermined level while being mechanically operated.

According to another aspect of the present disclosure, a method includes operating a turbocharger to advance pressurized combustion air from the turbocharger to (i) an internal combustion engine, and (ii) a fuel-fired burner of an emission abatement device via a flow path not including any combustion section of the engine. The method also includes determining if boost pressure of the turbocharger is below a predetermined level. Combustion air is advanced from a pressurized air tank of a vehicle air brake system to the fuel-fired burner if the boost pressure is below the predetermined level.

In lieu of using turbo boost pressure to trigger the introduction of combustion air from the pressurized air tank of the vehicle brake system, a flow sensor may be used to determine the magnitude of the flow of combustion air from the turbocharger to the fuel-fired burner. If this is below a predetermined magnitude, combustion air from the pressurized air tank of the vehicle brake system may be supplied to the fuel-fired burner.

Further, the introduction of combustion air from the pressurized air tank of the vehicle brake system may be triggered by an air/fuel sensor (i.e., a lambda sensor) positioned to sense the air-to-fuel ratio of the air/fuel mixture being combusted by the fuel-fired burner. If the air/fuel mixture drops below a predetermined level, combustion air from the pressurized air tank of the vehicle brake system may be supplied to the fuel-fired burner.

The above and other features of the present disclosure will become apparent from the following description and the attached drawings.

### BRIEF DESCRIPTION OF THE DRAWING

FIG. 1 is a simplified block diagram showing use of a turbocharger to supply pressurized air to an emission abatement device;

### DETAILED DESCRIPTION OF THE DRAWING

While the concepts of the present disclosure are susceptible to various modifications and alternative forms, specific exemplary embodiments thereof have been shown by way of example in the drawings and will herein be described in detail. It should be understood, however, that there is no intent to limit the disclosure to the particular forms disclosed, but on the contrary, the intention is to cover all modifications, equivalents, and alternatives following within the spirit and scope of the invention as defined by the appended claims.

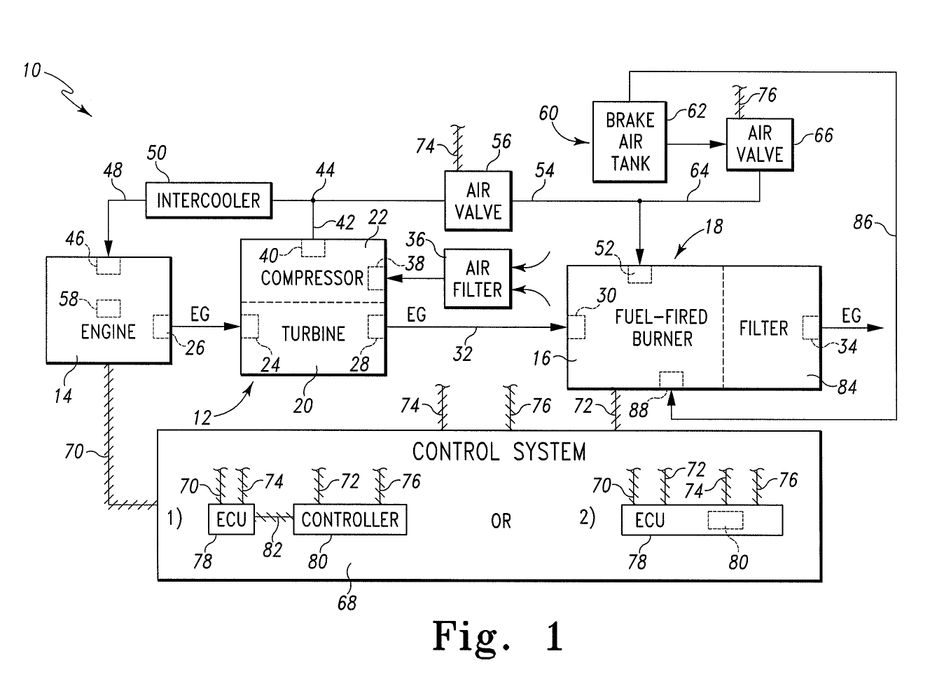

Referring to FIG. 1, there is shown an apparatus 10 in which a turbocharger 12 supplies pressurized air to both an internal combustion engine 14 (e.g., diesel engine) and a fuel-fired burner 16 of an emission abatement device 18 that is configured to remove emissions from the exhaust gas (“EG” in the drawings) of the engine 14. The engine 14 combusts fuel (e.g., diesel fuel) with pressurized air received from the turbocharger 12 in a combustion section of the engine 14. Exhaust gas generated by such combustion in turn operates the turbocharger 12. The fuel-fired burner 16 of the emission abatement device 18 combusts fuel (e.g., diesel fuel) with pressurized combustion air received from the turbocharger 12 to remove exhaust gas emissions.

The turbocharger 12 includes a turbine 20 and an air compressor 22 operated by the turbine 20. An exhaust gas inlet 24 of the turbine 20 is fluidly coupled to an exhaust gas outlet 26 of the engine 14 to receive exhaust gas therefrom. The exhaust gas flows through the turbine 20 which causes the turbine 20 to operate the air compressor 22. The exhaust gas then exits the turbine 20 through an exhaust gas outlet 28 to flow to an exhaust gas inlet 30 of the emission abatement device 16. The exhaust gas inlet 30 of the emission abatement device 18 is fluidly coupled to the exhaust gas outlet 28 of the turbine 20 via an exhaust line 32. After treatment by the emission abatement device 18, the exhaust gas exits the emission abatement device 18 through an exhaust gas outlet 34.

The air compressor 22 is mechanically coupled to the turbine 20 such that it is operated in response to flow of exhaust gas through the turbine 20. Operation of the air compressor 22 causes air (e.g., unpressurized air such as ambient air) to be advanced through an air filter 36 into an air inlet 38 of the air compressor 22. The air compressor 22 pressurizes the air and discharges the pressurized air through an air outlet 40 to an air supply line 42.

The stream of pressurized air in the air supply line 42 is divided at a junction 44 into an engine air stream and a device air stream. The engine air stream flows from the junction 44 to an air inlet 46 of the engine 14 (e.g., the engine's intake manifold) via an engine air line 48. An intercooler 50 in the engine air line 48 cools the engine air stream before it enters the engine 14. The air supply line 42 and the engine air line 48 thus cooperate to define a flow path for conducting pressurized air from the turbocharger 12 to the engine 14.

The device air stream flows from the junction 44 to a combustion air inlet 52 of the fuel-fired burner 16 of the emission abatement device 18 via a device air line 54. An air valve 56 in the device air line 54 is operable to control flow of pressurized air from the air compressor 22 to the fuel-fired burner 16. The air supply line 42 and the device air line 54 thus cooperate to define a flow path for conducting pressurized air from the turbocharger 12 to the fuel-fired burner 16 of the emission abatement device 18. This flow path does not include any combustion section 58 of the engine 16 (i.e., any engine combustion chamber) so that the pressurized air supplied to the emission abatement device 16 has not facilitated the combustion of fuel within the engine 14.

The air valve 56 may take a variety of forms. In some examples, the air valve 56 may be a proportional valve (e.g., butterfly valve). In other examples, the air valve 56 may be an on/off shut-off valve (e.g., solenoid valve) used in combination with an airflow-metering orifice in the device air line 54.

An auxiliary source 60 is fluidly coupled to the combustion air inlet 52 of the fuel-fired burner 16 of the emission abatement device 18. The auxiliary source 60 supplies combustion air to the fuel-fired burner 16 during periods of time when low boost pressure is experienced by the turbocharger 12. For example, during transient operating conditions (e.g., idle or low load conditions), boost pressure is low thereby reducing the amount of combustion air being supplied to the fuel-fired burner 16 of the emission abatement device 18. Similarly, low boost pressure can also be experienced as a result of momentary turbo lag during engine acceleration.

In the illustrative embodiment described herein, the auxiliary source 60 is embodied as the compressed air tank 62 of the vehicle's air brake system. An air line 64 couples the air tank 62 to the device air line 54. An air valve 66, such as a solenoid valve, is positioned in the air line 64 to control the flow of pressurized air from the air tank 62 to the inlet 52 of the fuel-fired burner 16. In such a way, during periods of time when low turbo boost pressure is experienced, combustion air may be supplied to the fuel-fired burner 16 from the air tank 62 of the vehicle's air brake system.

A control system 68 controls operation of the engine 14, the fuel-fired burner 16 of the emission abatement device 18, and the air valves 54, 66. The control system 68 is electrically coupled to the electronically-controlled components of the engine 14, along with numerous engine sensors, via a wiring harness 70 to control operation of the engine 14. The control system 68 is electrically coupled to the electronically-controlled components of the fuel-fired burner 16, along with numerous sensors associated with the emission abatement device, via a wiring harness 72 to control operation of the fuel-fired burner 16. The control system 68 is electrically coupled to the air valve 54 via an electrical line 74 to control operation of the valve 54, and is electrically coupled to the air valve 66 via an electrical line 76 to control operation of the air valve 66.

The control system 68 may take a variety of forms. In some examples, the control system 68 may include an engine control unit (“ECU”) 78 for controlling operation of the engine 14 and a separate controller 80 for controlling operation of the emission abatement device 18. In such a case, control of the air valves 54, 66 could be left to either the ECU 78 or the controller 80. The ECU 78 and the controller 80 may be electrically coupled to one another via a communication interface 82 (e.g., a CAN link) for communication therebetween. In other examples, the controller 80 is integrated into the ECU 78.

The fuel-fired burner 16 of the emission abatement device generates heat for burning particulate matter (i.e., soot) trapped by a particulate filter 84. The generated heat in combination with oxygen present in the exhaust gas oxidizes the trapped particulate matter so as to regenerate the filter 84 for further use. The control system 68 operates the fuel-fired burner 16 to regenerate the filter 84 on an as-needed basis, at regular or irregular time intervals (e.g., 1-4 times per day), and/or according to some other predetermined regeneration criteria. In addition to the filter 84, other emission components may be treated by heat from the fuel-fired burner 16. For example, a NO_{X} catalyst, such as a SCR catalyst, may be heated by the fuel-fired burner 16.

In addition to combustion air, the fuel-fired burner also receives pressurized fuel-atomization air from a pressurized air source. In the illustrative embodiment described herein, pressurized fuel-atomization air is supplied from the compressed air tank 62 of the vehicle's air brake system via an atomization air line 86. As used herein, the terms “atomization air” and “combustion air” are intended to define two separate air flows. In particular, atomization air is used to atomize the fuel prior to or during injection of the fuel into the fuel-fired burner 16 by a fuel injector 88. Combustion air is introduced into the burner separate from the fuel (i.e., it is not advanced through the fuel injector 88) and is used to facilitate combustion of the injected, atomized fuel. Under most operating conditions, combustion air is supplied from the turbocharger 12 and, as a result, has a lower pressure than the atomization air introduced from the compressed air tank 62 of the vehicle's air brake system. However, when turbo boost pressure is low (i.e., during transient operating conditions or as a result of turbo lag), the atomization air and the combustion air are introduced at the same pressure since they are from the same source (i.e., the compressed air tank 62 of the vehicle's air brake system).

A pair of electrodes under the control of the control system 68 ignites the atomized fuel in the combustion chamber of the fuel-fired burner where it combusts in the presence of the combustion air supplied by either the turbocharger 12 or, during low turbo boost conditions, the compressed air tank 62 of the vehicle's air brake system. Heat is thus generated by the fuel-fired burner 16 for use in regenerating the filter 84 or heating a NO_{X} catalyst.

Examples of fuel-fired burners which are suitable for use as the fuel-fired burner 16 of the present disclosure are described in U.S. patent application Ser. No. 10/931,028, which was filed Aug. 31, 2004 and U.S. patent application Ser. No. 10/894,548, which was filed Jul. 20, 2004. Both of these applications are assigned to the same assignee as the present application, and are hereby incorporated by reference.

In operation, the system provides combustion air to the fuel-fired burner 16 from the turbocharger 12 under most engine operating conditions. However, when turbo boost pressure drops below a predetermined level, the air valve 66 is opened and combustion air is supplied to the fuel-fired burner 16 from an auxiliary pressurized air source 60 (e.g., the compressed air tank 62 of the vehicle's air brake system). Once turbo boost pressure again increases above the predetermined level, the air valve 66 is closed and combustion air is again supplied to the fuel-fired burner from the turbocharger 12.

It should be appreciated that turbo boost pressure can be determined in any number of ways. Generally, turbo boost pressure is sensed and transmitted to the ECU 78 as a part of a conventional engine control strategy. Thus, data that is already present in most vehicle applications can be utilized to trigger the air valve 66. Otherwise, a dedicated sensor can be used in the device air line 54 to sense the air pressure being supplied to the fuel-fired burner 16. Engine load data or engine data may also be used to determine boost pressure, if need be.

It should also be appreciated that the air valves 54, 66 may be combined into a single three-way valve. In such a way, the three-way valve would selectively divert combustion air from either the turbocharger or the compressed air tank 62 of the vehicle's air brake system to the fuel-fired burner 16.

Moreover, the supplemental pressurized air source 60 may take on forms other than the compressed air tank 62 of the vehicle's air brake system. For example, an auxiliary electric air pump, such as those used with exhaust catalysts, may be used. A separate compressor, such as a supercharger, may be used as the supplemental pressurized air source 60. Depending on the configuration of the system, the supplemental pressurized air source may take the form of a valve which directs a greater portion of the engine's exhaust gas through the combustion chamber of the fuel-fired burner during low turbo boost conditions.

Further, the supplemental pressurized air source may be integrated into the turbocharger 12, along with an associated control configuration. In particular, an electrically assisted turbocharger may be used. In such a case, the turbocharger is mechanically operated by the engine's exhaust gas during normal operation, but then electrically operated to maintain combustion air supply to the fuel-fired burner 16 when needed by the burner if the turbo boost pressure falls below a predetermined level while being mechanically operated.

Yet further, in lieu of using turbo boost pressure to trigger the introduction of combustion air from the pressurized air tank 62 of the vehicle brake system (or other auxiliary air source), a flow sensor may be used to determine the magnitude of the flow of combustion air from the turbocharger 12 to the fuel-fired burner 16. To do so, an air flow sensor is positioned in the device air line 54 to sense the magnitude of the flow of air from the turbocharger 12 to the fuel-fired burner 16. If the magnitude of the flow of air is below a predetermined level, combustion air from the pressurized air tank 62 of the vehicle brake system may be supplied to the fuel-fired burner 16 in a similar manner to as described above (i.e., by controlling operation of the air valve 66).

Further, the introduction of combustion air from the pressurized air tank 62 of the vehicle brake system (or other auxiliary air source) may be triggered by an air/fuel sensor (i.e., a lambda sensor) positioned to sense the air-to-fuel ratio of the air/fuel mixture being combusted by the fuel-fired burner 16. If the air/fuel mixture drops below a predetermined level, combustion air from the pressurized air tank 62 of the vehicle brake system may be supplied to the fuel-fired burner 16 in a similar manner to as described above (i.e., by controlling operation of the air valve 66).

While the concepts of the present disclosure have been illustrated and described in detail in the drawings and foregoing description, such illustration and description is to be considered as exemplary and not restrictive in character, it being understood that only illustrative embodiments have been shown and described and that all changes and modifications that come within the spirit of the disclosure are desired to be protected.

There are a plurality of advantages of the concepts of the present disclosure arising from the various features of the systems described herein. It will be noted that alternative embodiments of each of the systems of the present disclosure may not include all of the features described yet still benefit from at least some of the advantages of such features. Those of ordinary skill in the art may readily devise their own implementations of a system that incorporate one or more of the features of the present disclosure and fall within the spirit and scope of the invention as defined by the appended claims.

1. A method, comprising the step of:
operating a turbocharger to advance pressurized combustion air from the turbocharger to (i) an internal combustion engine, and (ii) a fuel-fired burner of an emission abatement device via a flow path not including any combustion section of the engine,
determining if boost pressure of the turbocharger is below a predetermined level, and
advancing combustion air from a pressurized air tank of a vehicle air brake system to the fuel-fired burner if the boost pressure is below the predetermined level.

2. The method of claim 1, wherein the operating step comprises:
operating a turbine of the turbocharger with exhaust gas of the engine, and
operating an air compressor of the turbocharger in response to operation of the turbine to advance pressurized air from the air compressor to the engine and the fuel-fired burner.

3. The method of claim 1, further comprising:
advancing atomization air to the fuel-fired burner from the pressurized air tank of the vehicle air brake system,
atomizing fuel with the atomization air, and
injecting the atomized fuel into the fuel-fired burner.

4. The method of claim 1, wherein the advancing step comprises operating an air valve to control flow of the combustion air from the pressurized air tank of the vehicle air brake system to the fuel-fired burner.

5. The method of claim 1, further comprising:
determining if the boost pressure of the turbocharger is above the predetermined level, and
ceasing to advance combustion air from the pressurized air tank of the vehicle air brake system to the fuel-fired burner if the boost pressure is above the predetermined level.

6. The method of claim 1, further comprising:
operating the fuel-fired burner to combust fuel in the presence of combustion air from the pressurized air tank of a vehicle air brake system to generate heat, and
regenerating a particulate matter filter with the heat.

7. An apparatus, comprising:
an internal combustion engine,
an emission abatement device fluidly coupled to the engine to receive exhaust gas therefrom, the emission abatement device comprising a fuel-fired burner,
a turbocharger comprising an air compressor that is fluidly coupled to (i) an air intake of the engine, and (ii) the emission abatement device via a flow path not including any combustion section of the engine to supply pressurized combustion air to the fuel-fired burner, and
an auxiliary source fluidly coupled to the emission abatement device to supply pressurized combustion air to the fuel-fired burner, the auxiliary source being distinct from both the turbocharger and the engine.

8. The apparatus of claim 7, wherein the auxiliary source comprises a pressurized air tank of a vehicle air brake system.

9. The apparatus of claim 7, wherein the auxiliary source comprises an electric air pump.

10. The apparatus of claim 7, wherein the auxiliary source comprises a supercharger.

11. The apparatus of claim 7, wherein the auxiliary source comprises a second turbocharger.

12. The apparatus of claim 7, further comprising an air valve configured to control flow of pressurized air from the auxiliary source to the emission abatement device.

13. The apparatus of claim 12, further comprising a control system that is configured to control operation of the air valve based on turbo boost pressure of the turbocharger.

14. An apparatus, comprising:
a particulate filter,
a fuel-fired burner positioned upstream of the particulate filter and operable to generate heat for regeneration of the particulate filter,
a turbocharger comprising an air compressor fluidly coupled to the fuel-fired burner via a flow path not including any engine combustion section to supply pressurized combustion air to the fuel-fired burner, and
an air valve operable to divert combustion air from a pressurized air tank of a vehicle air brake system to the fuel-fired burner.

15. The apparatus of claim 14, further comprising a control system that is configured to control operation of the air valve based on boost pressure of the turbocharger.

16. A method, comprising the step of:
operating a turbocharger with the exhaust gas of an internal engine to advance pressurized combustion air from the turbocharger to a fuel-fired burner of an emission abatement device via a flow path not including any combustion section of the engine,
determining if boost pressure of the turbocharger is below a predetermined level, and
advancing combustion air from an auxiliary source to the fuel-fired burner if the boost pressure is below the predetermined level, wherein the auxiliary source is distinct from both the engine and the turbocharger.

17. A method, comprising the step of:
mechanically operating an electrically-assisted turbocharger with the exhaust gas of an internal engine to advance pressurized combustion air from the turbocharger to a fuel-fired burner of an emission abatement device via a flow path not including any combustion section of the engine,
determining if boost pressure of the turbocharger is below a predetermined level, and
electrically operating the electrically-assisted turbocharger to advance pressurized combustion air from the turbocharger to the fuel-fired burner via the flow path not including any combustion section of the engine if the boost pressure of the turbocharger is below the predetermined level.

18. A method, comprising the step of:
operating a turbocharger to advance pressurized combustion air from the turbocharger to (i) an internal combustion engine, and (ii) a fuel-fired burner of an emission abatement device via a flow path not including any combustion section of the engine,
determining if the magnitude of the flow of pressurized combustion air from the turbocharger to the fuel-fired burner is below a predetermined level, and
advancing combustion air from a pressurized air tank of a vehicle air brake system to the fuel-fired burner if the magnitude of the flow of pressurized combustion air from the turbocharger to the fuel-fired burner is below the predetermined level.

19. A method, comprising the step of:
operating a turbocharger to advance pressurized combustion air from the turbocharger to (i) an internal combustion engine, and (ii) a fuel-fired burner of an emission abatement device via a flow path not including any combustion section of the engine,
determining if the air-to-fuel ratio of the air/fuel mixture being combusted by the fuel-fired burner is below a predetermined level, and
advancing combustion air from a pressurized air tank of a vehicle air brake system to the fuel-fired burner if the air-to-fuel ratio of the air/fuel mixture being combusted by the fuel-fired burner is below the predetermined level.
